(19) United States
(12) Patent Application Publication
(10) Pub. No.: US 2021/0221109 A1
(43) Pub. Date: Jul. 22, 2021

(54) BACK PANEL FOR A VEHICLE SEAT

(71) Applicant: ADIENT ENGINEERING AND IP GMBH, BURSCHEID (DE)

(72) Inventor: Ronald G. Bedro, Plymouth, MI (US)

(73) Assignee: ADIENT ENGINEERING AND IP GMBH, BURSCHEID (DE)

(21) Appl. No.: 16/967,473

(22) PCT Filed: Feb. 11, 2019
(86) PCT No.: PCT/EP2019/053248

§ 371 Date: Aug. 5, 2020

Related U.S. Application Data
(60) Provisional application No. 62/629,155, filed on Feb. 12, 2018.

(51) Int. Cl. B32B 27/12; B32B 5/26

(52) U.S. Cl. CPC B32B 27/12; B32B 5/022; B32B 5/26

(57) ABSTRACT

A back panel for a vehicle seat is described. The back panel may have an upper layer, a lower layer supporting the upper layer, an adhesive layer arranged between the upper layer and the lower layer and fixing the upper layer to the lower layer, and a toe kick having a first end portion abutting a bottom of the upper layer. The lower layer and the adhesive layer extend beyond the bottom of the upper layer to the first end portion of the toe kick, and the first end portion of the toe kick is fixed to the lower layer by the adhesive layer.

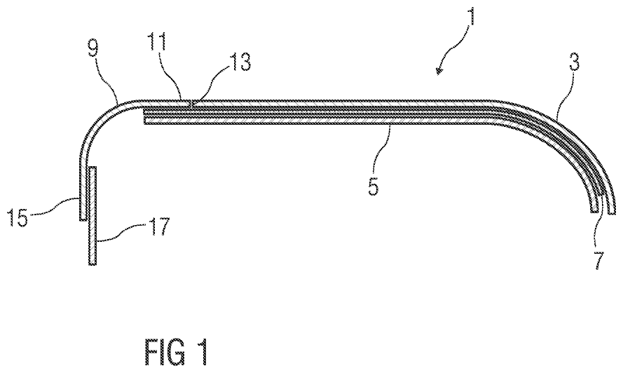

### BACKGROUND OF THE DISCLOSURE

The present disclosure generally relates to vehicle seats, and more particularly to back panels of vehicle seats and manufacturing of back panels of vehicle seats.

Vehicle seats, back panels of vehicle seats, and methods of manufacturing back panels of vehicle seats are generally known in the state of the art.

### SUMMARY OF THE DISCLOSURE

It is an object of the present disclosure to provide an improved back panel for a vehicle seat, and a method of manufacturing such a back panel.

According to the disclosure, the object is solved concerning the back panel by the features of claim 1 and concerning the method of manufacturing by the features of claim 8.

A back panel for a vehicle seat according to the invention comprises an upper layer, a lower layer supporting the upper layer, an adhesive layer arranged between the upper layer and the lower layer and fixing the upper layer to the lower layer, and a toe kick having a first end portion abutting a bottom of the upper layer. The lower layer and the adhesive layer extend beyond the bottom of the upper layer to the first end portion of the toe kick, and the first end portion of the toe kick is fixed to the lower layer by the adhesive layer.

A method of manufacturing a back panel for a vehicle seat according to the invention comprises the steps of:

placing in a tool a stack formed of a lower layer material, an adhesive, an upper layer material and a toe kick material, wherein a first end portion of the toe kick material abuts a bottom of the upper layer material, the adhesive is placed between the upper layer material and the lower layer material, and the lower layer material and the adhesive extend beyond the bottom of the upper layer material to the first end portion of the toe kick material; and
welding the stack to form a one piece back panel comprising a lower layer, an adhesive layer, an upper layer and a toe kick. A second end portion of the toe kick material may be protected from the welding process when manufacturing the back panel. For instance, a second end portion of the toe kick material may extend from the tool when manufacturing the back panel. In this way, the second end portion of the toe kick is not affected by the welding process. In particular, the second end portion of the toe kick is prevented from being damaged by the welding process.

An alternative method of manufacturing a back panel for a vehicle seat according to the invention comprises the steps of:

placing in a tool a stack formed of a lower layer material, an adhesive and an upper layer material, with the adhesive placed between the upper layer material and the lower layer material;
welding the stack to form an upper layer fixed to a lower layer; and
attaching a toe kick to the upper layer or to the lower layer. For instance, the toe kick may be attached to the upper layer or to the lower layer by sewing or by a zipper.

A back panel for a vehicle seat according to the invention thus has a toe kick to prevent the feet of a user seated behind the vehicle seat with the toe kick from contacting equipment such as brackets or wires. When the toe kick is integrated into the back panel when manufacturing the backpanel by welding, no manual, labor intensive process is required to attach a toe kick to the back panel by sewing, velcro or other attachment methods.

In an embodiment of the invention the lower layer and the adhesive layer extend 5 mm to 150 mm beyond the bottom of the upper layer. This provides a sufficient area of the adhesive layer and the lower layer to firmly fix the toe kick.

In another embodiment of the invention the upper layer material is polyvinyl chloride or thermoplastic polyurethane or leather or textile. All these materials can provide an upper layer with appropriate elasticity and comfortable haptic features.

In another embodiment of the invention the lower layer material is a non-woven material. Woven materials have anisotropic distension features which make them inappropriate lower layer materials.

In another embodiment of the invention the toe kick material is a carpet material or polyvinyl chloride or thermoplastic polyurethane or leather or textile. All these materials can provide a toe kick with appropriate pliability when moving or tilting the vehicle seat.

In another embodiment of the invention the toe kick is bent approximately 90 degrees. This allows a portion of the toe kick to extend approximately in parallel with either the vehicle seat or the floor beneath the vehicle seat.

A vehicle seat according to the invention comprises a back panel according to the invention.

### BRIEF DESCRIPTION OF THE DRAWING

The present disclosure will become more fully understood from the detailed description given herein below and the accompanying drawing which is given by way of illustration only, and thus, is not limitative of the present disclosure, wherein the FIGURE shows a sectional view of an exemplary embodiment of a back panel for a vehicle seat.

### DETAILED DESCRIPTION OF PREFERRED EMBODIMENTS

The FIGURE shows a sectional view of a back panel 1 of a vehicle seat. The back panel 1 comprises an upper layer 3, a lower layer 5, an adhesive layer 7 and a toe kick 9.

The adhesive layer 7 is arranged between a rear surface of the upper layer 3 and a front surface of the lower layer 5 and fixes the upper layer 3 to the lower layer 5.

The toe kick 9 has a first end portion 11 abutting a bottom 13 of the upper layer 3. A second end portion 15 of the toe kick 9 is bent approximately 90 degrees relatively to the first end portion 11 towards the rear side of the back panel 1.

The lower layer 5 and the adhesive layer 7 extend 5 mm to 150 mm beyond the bottom 13 of the upper layer 3 to the first end portion 11 of the toe kick 9. The first end portion 11 of the toe kick 9 is fixed to the lower layer 5 by the adhesive layer 7.

The upper layer 3 is made of polyvinyl chloride or thermoplastic polyurethane or leather or textile.

The lower layer 5 is made of a non-woven material.

The toe kick 9 is made of a carpet material or polyvinyl chloride or thermoplastic polyurethane or leather or textile.

The second end portion 15 of the toe kick 9 is attached to an elastic 17 or stretchy or flexible material which is connected to a bottom part of the vehicle seat and allows the toe kick 9 to move when the seat back is tilted.

The back panel 1 is manufactured by welding. To this end a stack formed of a lower layer material, an adhesive, an upper layer material and a toe kick material is placed in a tool, with a first end portion of the toe kick material abutting a bottom of the upper layer material, the adhesive placed between the upper layer material and the lower layer material, and the lower layer material and the adhesive extending beyond the bottom of the upper layer material to the first end portion of the toe kick material. Subsequently the stack is welded to form a one piece back panel 1 comprising the lower layer 5, the adhesive layer 7, the upper layer 3 and the toe kick 9. A second end portion of the toe kick material may be protected from the welding process, and/or may extend from the tool.

Alternatively, a toe kick may be accomplished by extending the upper layer 3 and attaching the elastic 17 or stretchy or flexible material to a bottom surface of the upper layer 3 via welding or sewing.

### LIST OF REFERENCES

1 back panel
3 upper layer
5 lower layer
7 adhesive layer
9 toe kick
11 first end portion
13 bottom of upper layer
15 second end portion
17 elastic

1-17. (canceled)

18. A back panel for a vehicle seat, the back panel comprising:
an upper layer;
a lower layer supporting the upper layer;
an adhesive layer arranged between the upper layer and the lower layer and fixing the upper layer to the lower layer;
a toe kick having a first end portion abutting a bottom of the upper layer;
wherein the lower layer and the adhesive layer extend beyond the bottom of the upper layer to the first end portion of the toe kick, and the first end portion of the toe kick is fixed to the lower layer by the adhesive layer.

19. The back panel of claim 18, wherein the lower layer and the adhesive layer extend 5 mm to 150 mm beyond the bottom of the upper layer.

20. The back panel of claim 18, wherein the upper layer is made of polyvinyl chloride or thermoplastic polyurethane or leather or textile.

21. The back panel of claim 18, wherein the lower layer is made of a non-woven material.

22. The back panel of claim 18, wherein the toe kick is made of a carpet material or polyvinyl chloride or thermoplastic polyurethane or leather or textile.

23. The back panel of claim 18, wherein the toe kick is bent approximately 90 degrees.

24. A method of manufacturing a back panel for a vehicle seat, comprising the steps of:
placing in a tool a stack formed of a lower layer material, an adhesive, an upper layer material and a toe kick material, with a first end portion of the toe kick material abutting a bottom of the upper layer material, the adhesive placed between the upper layer material and the lower layer material, and the lower layer material and the adhesive extending beyond the bottom of the upper layer material to the first end portion of the toe kick material; and
welding the stack to form a one piece back panel comprising a lower layer, an adhesive layer, an upper layer and a toe kick.

25. The method of claim 24, wherein a second end portion of the toe kick material is protected from the welding process.

26. The method of claim 24, wherein a second end portion of the toe kick material extends from the tool.

27. A method of manufacturing a back panel for a vehicle seat, comprising the steps of:
placing in a tool a stack formed of a lower layer material, an adhesive and an upper layer material, with the adhesive placed between the upper layer material and the lower layer material;
welding the stack to form an upper layer fixed to a lower layer; and
attaching a toe kick to the upper layer or to the lower layer.

28. The method of claim 27, wherein the toe kick is attached to the upper layer or to the lower layer by sewing or by a zipper.

29. The method of claim 27, wherein the lower layer material and the adhesive extend 5 mm to 150 mm beyond the bottom of the upper layer.

30. The method of claim 27, wherein the upper layer material is polyvinyl chloride or thermoplastic polyurethane or leather or textile.

31. The method of claim 27, wherein the lower layer material is a non-woven material.

32. The method of claim 27, wherein the toe kick material is a carpet material or polyvinyl chloride or thermoplastic polyurethane or leather or textile.

33. The method of claim 27, wherein the toe kick is bent approximately 90 degrees.
